(19) United States
(12) Patent Application Publication
(10) Pub. No.: US 2026/0151745 A1
(43) Pub. Date: Jun. 4, 2026

(54) ULTRAFINE BUBBLE WATER GENERATOR AND STRUCTURE BODY THEREOF

(71) Applicant: GUANGDONG FUJI KEIKI SCIENCE &TECHNOLOGY CO.,LTD, Guangzhou (CN)

(72) Inventors: Haifeng DU, Guangzhou (CN); MASASHI ITO, Guangzhou (CN)

(73) Assignee: GUANGDONG FUJI KEIKI SCIENCE &TECHNOLOGY CO.,LTD, Guangzhou (CN)

(21) Appl. No.: 19/393,587

(22) Filed: Nov. 19, 2025

Related U.S. Application Data
(63) Continuation of application No. PCT/CN2024/135566, filed on Nov. 29, 2024.

(51) Int. Cl. B01F 23/2375; B01F 23/232; B01F 23/237; B01F 25/421; B01F 101/00

(52) U.S. Cl. CPC B01F 23/2375; B01F 23/232; B01F 23/237611; B01F 25/4233; B01F 2101/305; B01F 2215/0431

(57) ABSTRACT

To provide a ultrafine bubble water generator and structural body thereof with a simple structure and small size, low cost and excellent versatility. Provided is a structural body 100 of a ultrafine bubble water generator capable of making bubbles contained in tap water finer to produce water including many ultrafine bubbles, the structural body comprising: a water intake surface body 11 disposed on the inlet side of tap water; a water output surface body 12 disposed on the outlet side; and a hollow cylindrical body 10, wherein the cylindrical body 10, the water intake surface body and the water output surface body of the structural body are selected to have an outer diameter that fits the inner wall of a tap water supply pipe for supplying the tap water, and previously inserted and set.

### CROSS-REFERENCE TO RELATED APPLICATIONS

The application claims priority to Japanese patent application No. 2023-171828, filed on Oct. 3, 2023, the entire contents of which are incorporated herein by reference.

### TECHNICAL FIELD

The present invention relates to a ultrafine bubble water generator and structural body thereof for making bubbles in tap water finer, for versatile use in apparatus such as laundry machine and automatic dish washer, as well as shower head and various tools of lavatory and sink, where tap water is used easily in low cost, and a structural body thereof.

### BACKGROUND

ultrafine bubble water used herein means water including a lot of air in micrometer/nanometer order, specifically having a diameter of bubble contained in water of approximately 100 um or less (diameter: 50˜500nm). In recent years, it is used for various uses as shower water and face washing water for beauty and healthy purpose, because water has a dense texture and bubble water finer than the pores of human body penetrates into pores and sweat gland to effectively remove soils.

Such ultrafine bubble water also becomes smooth without water molecule being bonded to each other as a mass, and thus penetrates into a gap between fibers of clothes etc., and closely contacts with the surface of dishes etc. Therefore, it is widely used as a washing water including laundry water, dish washing water and stool washing water.

Furthermore, ultrafine bubble water attracts attention for its cleansing effects due to the electrical effect of ultrafine bubbles contained therein. Specifically, the surface of ultrafine bubbles contained in ultrafine bubble water is usually negatively charged and ultrafine bubble water clusters repel each other due to charge effects to separate finely in water, diffuse and float. In contrast, soils due to oils, sebum and small debris etc. are often positively charged, and thus electrically connected to a cleanable product negatively charged. Once ultrafine bubble negatively charged absorbs soils positively charged, soils get electrically neutral, thereby making soils easy to separate from cleanable products. Furthermore, it is known that soils separated by electrical neutralization from a cleanable product float up to water level by buoyancy of bubble while being absorbed on gas/liquid interface of ultrafine bubble, and in this way, soils removed from the cleanable product are cleaned away without being attached to the cleanable product again in ultrafine bubble water.

There are known methods of generating such ultrafine bubble water containing many ultrafine bubbles: high-speed shearing type; high pressure breaking type; and cavitation type etc. of tap water. Most of these types adopt aspirator type, i.e. the introduction of ultrafine bubbles into tap water through the aspiration of the outside air. As one example, micro bubble generation device is known. This device accelerates liquid by accelerating means, introduces gas (bubble with a diameter of several millimeters) into a casing by a liquid/gas mixing means to produce a mixed fluid, and causes the cavitation of the mixed fluid within casing to generate micro bubbles (e.g. see Patent Literature 1).

Unlike the apparatus of Patent Literature 1 taking the outside air, it is also known that a relatively large size of bubble dissolved into water is subjected to cavitation type to generate micro bubbles. One example of such cavitation type ultrafine bubble generation may include, for example, ultrafine bubble generation apparatus comprising: a first nozzle at water channel inlet with its cross section orthogonal to the center axis of the nozzle gradually decreasing from the inlet of tap water flow to the outlet; a second nozzle disposed at water channel outlet continuously via a communication channel in communication with the outlet of the first nozzle with its cross section orthogonal to the center axis of the nozzle gradually increasing from the inlet of tap water flow to the outlet; and a gap or side room only open to the communication channel (e.g. see Patent Literature 2).

Furthermore, a shower head is known as one application example of micro bubble producing device for beauty and healthy effects, in which micro bubble is generated by cavitation from air dissolved in water (e.g. see Patent Literature 3).

Recently, laundry machine, cleansing device and lavatory etc. with a function of generating ultrafine bubble water are known (e.g. see Patent Literature 4 for laundry machine), and widely sold.

### Prior Art Document

### Patent Literature

[Patent Document 1] Japanese Unexamined Patent Application Publication No. 2007-21343
[Patent Literature 2] Japanese Unexamined Patent Application Publication No. 2009-136864
[Patent Document 3] Japanese Unexamined Patent Application Publication No. 2016-2196
[Patent Document 4] Japanese Unexamined Patent Application Publication No. 2022-185360

### SUMMARY

### Problem to be solved by the invention

Micro bubble generation apparatus of Patent Literature 1 requires a large device to conduct liquid/gas mixing by accelerating water stored in a tank, and thus is not suitable for the use in generating ultrafine bubble water from tap water to be supplied to household.

Micro bubble generation apparatus of Patent Literature 2 depressurizes through the squeezing of the second nozzle water flow rapidly expanded in the communication channel comprising a side room to form water channel. The apparatus has a complicated structural body, which results in high cost. It is thus difficult to install on household bathroom shower and tools of lavatory etc. and apparatuses such as laundry machine and dish washing device.

Patent Literature 3 is a shower head for household use complete with built-in micro bubble generator (ultrafine bubble water generator) within shower head to be installed in bathroom. If such micro bubble generator is housed in shower head, the shower head becomes larger compared to the normal one. On the other hand, if each component of such micro bubble generator is downsized to allow space within common size shower head, water flow channel gets narrower within micro bubble generator, and water pressure is reduced, which results in the insufficient water flow amount.

The apparatus of Patent Literature 4 embeds the device for generating ultrafine bubble water therein in the manufacturing process of laundry machine. This does not provide shower head or apparatus such as laundry machine currently used in household with the additional function of generating ultrafine bubble water.

On the other hand, you may find the case where the ultrafine bubble water generator is solely sold, and consumers buy it and install the device by themselves or ask plumbing business to install the device on tap water pipe or tube for supplying tap water to the existing shower head or lavatory in household. In such case, however, the cut of tap water pipe or the connection of the ultrafine bubble water generator to the tap water pipe is required for the installation of the ultrafine bubble water generator on shower head or metal pipe or flexible tube made of resin etc. that supplies tap water to lavatory. Such work requires certain time for skilled workers to do without water leak due to threading work of tap water pipe or water leak treatment, and thus has a great difficulty.

FIG. 13 shows (a) the appearance of the commonly known ultrafine bubble water generator and (b) an example of its inner structure.

As shown in FIG. 13(b), the known ultrafine bubble water generator increases water flow speed and vigorously strikes bubbles or dissolved air contained in tap water against wall blocking water flow to produce many ultrafine bubbles. This results in the complex inner structure and its appearance having concave/convex shape.

In the known ultrafine bubble water generator, if it is installed on tap water pipe or water flowing pipe within the device, or tap water pipe or water flowing pipe is cut and installed without water leak, water intake end and water outflow end of the ultrafine bubble water generator are threaded (external thread) and screwed (internal thread) in the part of the threaded inner wall of tap water pipe, and jointed with nut. Therefore, it is difficult for general consumers to perform such a task, and there is no other choice but to request the services of a professional plumber.

Furthermore, for example, as shown in FIG. 13, the inner structure of the device for generating ultrafine bubble is too complex to produce the device in low cost. Moreover, the water flowing resistance inside the device becomes too large. Therefore, especially in the housing located on a hill, housing located away from the supply source of tap water and higher floors of cluster housing such as mansion and apartment where the supply water pressure of tap water is too low, it is often the case that water pressure of water flow flowing through the ultrafine bubble water generator is reduced, which makes the ultrafine bubble water generator unavailable.

Therefore, the present invention has been made in view of the problems of the conventional ultrafine bubble water generator. The purpose of the invention is to meet the following requirements (a) to (e) with good balance, Specifically,
(a) To provide a structural body of a ultrafine bubble water generator for versatile use in apparatus such as laundry machine and automatic dish washer, as well as shower head and lavatory and sink devices, where tap water is used.
(b) Small, simple and low cost.
(c) To suppress the loss of the supply water pressure of ultrafine bubble water as much as possible to be supplied from the ultrafine bubble water generator upon installation.
(d) Having performance to produce certain number or more of ultrafine bubbles in tap water.
(e) User itself or operator can easily install the device in a short time on the existing shower head and tools of toilet and lavatory already used in household, as well as water supply pipe or tube to an apparatus such as laundry machine and automatic dish washer. Specifically, low cost for installation.

### Means for Solving Problem

The present invention provides a structural body of a ultrafine bubble water generator capable of making bubbles contained in tap water finer to produce water including many ultrafine bubbles, the structural body comprising: a water intake surface body disposed on the inlet side of tap water, the water intake surface body having branching holes for branching tap water flow into the interior of the structural body into plural inflows; a water output surface body disposed on the outlet side from the structural body, the water output surface body having branching holes installed on the outlet side from the structural body for branching the outflow of ultrafine bubble water produced inside of the structural body into plural outflows; and a hollow cylindrical body supporting the outer circumferential surfaces of the water intake surface body and the water output surface body, wherein the cylindrical body, the water intake surface body and the water output surface body of the structural body are selected to have an outer diameter that fits the inner wall of a tap water supply pipe for supplying the tap water or various water flowing tubes, and previously inserted and set in the tap water supply pipe.

In this way, the structural body of the ultrafine bubble water generator according to the present invention especially comprises:
(a) a water intake surface body disposed on the inlet side of tap water, the water intake surface body having branching holes for branching tap water flow into the interior of the structural body into plural inflows; a water output surface body disposed on the outlet side from the structural body, the water output surface body having branching holes for branching the outflow of ultrafine bubble water produced inside of the structural body into plural outflows; and a hollow cylindrical body supporting the outer circumferential surfaces of the water intake surface body and the water output surface body. This allows us to easily produce ultrafine bubble water containing many micrometer or nanometer-order ultrafine bubbles in low cost with simple structure and excellent versatility. Furthermore,
(b) For the structural body of the ultrafine bubble water generator, cylindrical body, water intake surface body and water output surface body may be selected to have an appropriate outer diameter that fits the inner wall of a tap water supply pipe for supplying tap water or various water flowing tubes, and previously inserted and set. This structure allows the operator to complete the installation of the ultrafine bubble water generator (structural body) easily in a short time.

The number of the branching holes in the water intake surface body is identical to the number of the branching holes in the water output surface body, allowing the same component to be used for water intake surface body or water output surface body, achieving lower cost.

Furthermore, the structural body of the ultrafine bubble water generator may further comprise one or a plurality of intermediate water flow diverter(s) inside the cylindrical body for branching water flow into plural flows in a water flowing channel from the water intake surface body to the water output surface body. This allows ultrafine bubbles contained in water to be finer to produce more bubbles.

Further, the branching holes in the water output surface body or the intermediate water flow diverter(s) may respectively have a circular shape or an ellipsoidal shape. The number of the branching holes in the intermediate water flow diverter(s) may be identical to the number of the branching holes in the water intake surface body and the water output surface body. The number of the branching holes in the water intake surface body, the water output surface body and the intermediate water flow diverter(s) may be 3 or 4. This allows us to use the same one for intermediate water flow diverter as well as water intake surface body or water output surface body. The branching holes having a circular shape or an ellipsoidal shape may reduce manufacturing cost.

In this configuration, when viewed from water flowing direction from the water intake surface body to the water output surface body, the water intake surface body, the intermediate water flow diverter(s) and the water output surface body may be disposed in such a manner that center positions of the respective branching holes may not coincide with each other but have a difference in a circumferential direction. This results in most of water flowing into the water intake surface body striking the intermediate water flow diverter and the water output surface body without passing straight through the inside of the structural body, thereby making ultrafine bubbles contained in water finer to produce more bubbles.

Furthermore, the water intake surface body and the water output surface body may be made from a resin material, stainless material or braze material having a thickness of at least 6 mm, and the branching holes in the water intake surface body and the water output surface body may be disposed in a manner that center axes of the branching holes may tilt against the axis of the tap water supply pipe toward the water flowing direction. This allows water passing though the interior of the structural body to make swirl, and apply a pressure to air dissolved into water to make air in water micro bubbles.

Furthermore, water flow flowing out from the water output surface body strikes the inner wall of a tap water supply pipe for supplying tap water or water flowing tubes having various sizes. This water flowing tube itself contributes to the ultrafine bubble generation together with the structural body of the ultrafine bubble water generator.

In this configuration, a tilt of the branching holes against the axis of the tap water supply pipe in the water intake surface body may be opposite to a tilt of the branching holes against the axis of the tap water supply pipe in the water output surface body.

Therefore, the intermediate water flow diverter(s) is made from a resin material, stainless material or braze material having a thickness of at least 6 mm, and the branching holes in the intermediate water flow diverter(s) may be disposed in a manner that center axes of the branching holes may tilt against the axis of the tap water supply pipe toward the water flowing direction. This makes ultrafine bubbles contained in water finer to produce more bubbles.

Furthermore, when viewed from water flowing direction from the water intake surface body to the water output surface body, the water intake surface body, the intermediate water flow diverter(s) and the water output surface body may be disposed in such a manner that center positions of the respective branching holes may not coincide with each other but have a predetermined angle difference in a circumferential direction.

A tilt of the branching holes against the axis of the tap water supply pipe in the water intake surface body may be opposite to a tilt of the branching holes against the axis of the tap water supply pipe in the intermediate water flow diverter(s).

In this configuration, a tilt of the branching holes made in the water intake surface body against the axis of the tap water supply pipe, a tilt of the branching holes in one or a plurality of the intermediate water flow diverter(s) and a tilt of the branching holes in the water output surface body may be opposite to each other sequentially in water flowing direction, and each branching hole may be arranged so that a tap water flow in a cylindrical body of the structural body may swirl by a tilt of each branching hole each time when the tap water flow passes through the water intake surface body, one or a plurality of the intermediate water flow diverter(s) and the water output surface body, thereby turning the tap water flow into a turbulent flow. This results in water flow flowing within the structural body in turbulent condition to strike the intermediate water flow diverter and the water output surface body, thereby making ultrafine bubbles contained in water finer to produce more bubbles.

Furthermore, the branching holes in the water intake surface body, the water output surface body or the intermediate water flow diverter(s) may be configured to have a concave/convex inner surface for producing turbulent flow. Otherwise, the branching holes in the water intake surface body, the water output surface body or the intermediate water flow diverter(s) may be configured to have a plurality of trenches for producing turbulent flow in a water flowing direction or a direction intersecting the water flowing direction.

The present invention further provides a ultrafine bubble water generator comprising: a structural body of the aforementioned ultrafine bubble water generator; and one or a plurality of water flow blocker(s) supported by an inner wall within a cylindrical body of the structural body between the water intake surface body and the water output surface body, between the water intake surface body and the intermediate water flow diverter or between the intermediate water flow diverter and the water output surface body for blocking a part of water flow flowing within the cylindrical body. the water flow blocker may block water flow flowing through the center part of cylindrical body of the structural body, or block water flow flowing through the circumferential part of cylindrical body of the structural body. This allows water flowing within the structural body to strike water flow blocker in turbulent condition, thereby making ultrafine bubbles contained in water finer to produce more bubbles.

### BRIEF DESCRIPTION OF THE DRAWINGS

FIG. 1 shows the first example (corresponding to claim 1) of the structural body of the ultrafine bubble water generator according to the present invention and the state where the structural body has been installed within the tap water supply pipe.

FIG. 2 shows the second example (corresponding to claim 3 with one intermediate water flow diverter) of the structural body of the ultrafine bubble water generator according to the present invention.

FIG. 3 shows the third example (corresponding to claim 3 with two intermediate water flow diverters) of the structural body of the ultrafine bubble water generator according to the present invention.

FIG. 4 shows the example where one water flow blocker is installed in the above first example of the structural body of the ultrafine bubble water generator according to the present invention (corresponding to claim 16).

FIG. 5 shows the example where one water flow blocker is installed in the above third example of the structural body of the ultrafine bubble water generator according to the present invention (corresponding to claim 16).

FIG. 6 shows the example where two water flow blockers are installed in the above third example of the structural body of the ultrafine bubble water generator according to the present invention (corresponding to claim 16).

FIG. 7 shows the positions of branching holes (circular branching holes) viewed from the water flowing direction of water intake surface body, water output surface body and intermediate water flow diverter composing the structural body of the ultrafine bubble water generator according to the present invention. (a) shows the example where three branching holes are made vertical to the water flowing direction, whereas (b) shows the example where four branching holes are made vertical to the water flowing direction (corresponding to claim 2).

FIG. 8 shows the positions of branching holes (circular branching holes) viewed from the water flowing direction of water intake surface body, water output surface body and intermediate water flow diverter composing the structural body of the ultrafine bubble water generator according to the present invention. (a) shows the example where three branching holes are made so as to be tilted toward the water flowing direction, whereas (b) shows the example where four branching holes are made so as to be tilted toward the water flowing direction (corresponding to claim 7, 8 11).

FIG. 9 shows one example of the shape of the branching holes other than circular shape viewed from the water flowing direction of water intake surface body, water output surface body and intermediate water flow diverter composing the structural body of the ultrafine bubble water generator according to the present invention. (a) shows an example of three elliptical-shaped branching holes. (b) shows an example of four elliptical-shaped branching holes. (c) shows an example of three triangular-shaped branching holes. (d) shows an example of four triangular-shaped branching holes. Branching holes having each shape as shown in FIG. 9 are made vertical to the water flow as shown in

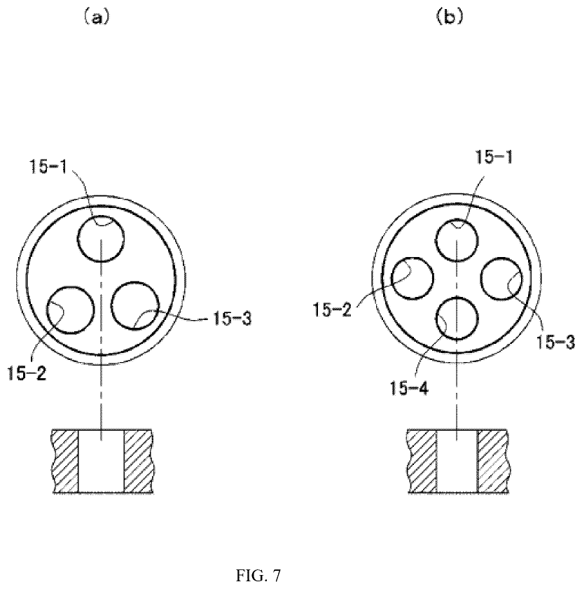

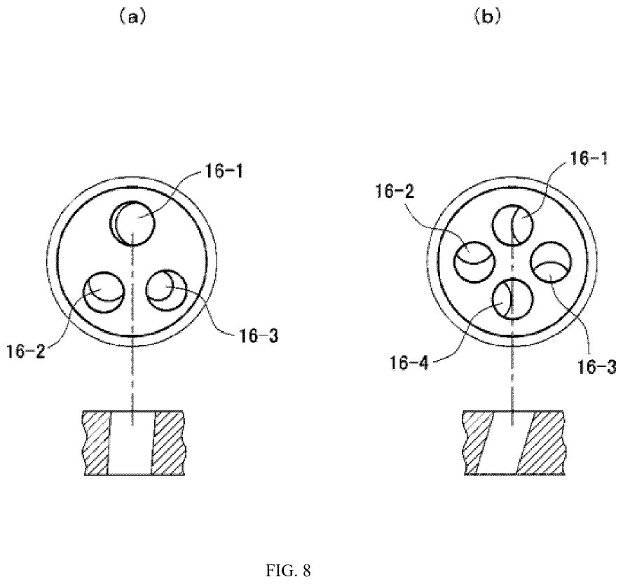

FIG. 7, or made so as to be tilted toward water flowing direction as shown in FIG. 8. the example where three branching holes are made vertical to the water flowing direction, whereas (b) shows the example where four branching holes are made vertical to the water flowing direction ((a) and (b) correspond to claim 3).

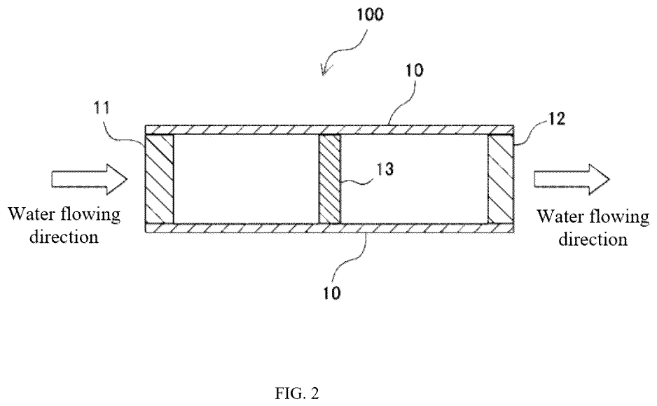

FIG. 10 corresponds to claims 6 and 10 in the second example of the structural body of the ultrafine bubble water generator according to the present invention as shown in FIG. 2. (a) shows an example of the relative position of each branching holes in the water intake surface body, water output surface body and intermediate water flow diverter when viewed from water flowing direction. (b) shows the positions of the branching holes in the water intake surface body, water output surface body and intermediate water flow diverter when viewed from water flowing direction.

FIG. 11 shows an example of irregular marks for causing turbulent flow which are formed on inner surface of branching holes made on water intake surface body, water output surface body and intermediate water flow diverter.

FIG. 12 shows an example of intermediate water flow diverter. (a) shows an example of blocking water flowing the circumferential part within cylindrical body of the structural body. (b) shows an example of blocking water flowing the central part within cylindrical body of the structural body.

FIG. 13 shows (a) the appearance of the commonly known ultrafine bubble water generator and (b) an example of its inner structure.

### Explanation of Symbols

100 structural body of a ultrafine bubble water generator 100
10 cylindrical body
11 water intake surface body
12 water output surface body
13, 13-1, 13-2 intermediate water flow diverter
14, 14-1, 14-2 water flow blocker
15, 15-1, 15-2, 15-3, 15-4 branching holes (vertical direction/circular)
16, 16-1, 16-2, 16-3, 16-4 branching holes (tilt direction/circular)
17, 17-1, 17-2, 17-3, 17-4 branching holes (elliptical)
18, 18-1, 18-2, 18-3, 18-4 branching holes (triangle)
20 Example of concave/convex structure (aligned trenches) formed on the inner wall of circular branching holes
21 Example of concave/convex structure (projection) formed on the inner wall of circular branching holes
23 Example of concave/convex structure (aligned trenches) formed on the inner wall of triangular branching holes

### DETAILED DESCRIPTION OF THE EMBODIMENTS

Hereinafter, the embodiments of the structural body of a ultrafine bubble water generator according to the present invention and the embodiments of the ultrafine bubble water generator are elaborated with reference to the drawings.

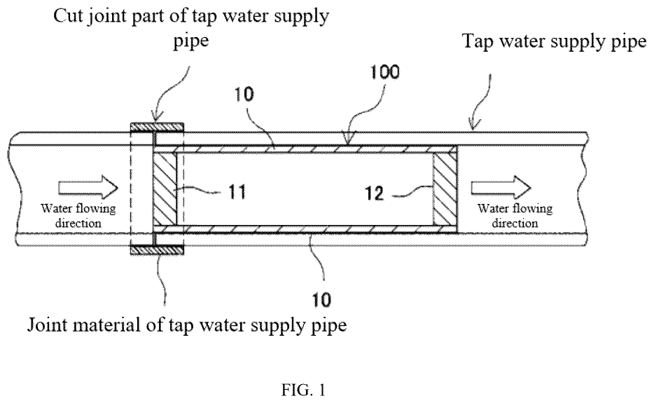

FIG. 1 shows the first example of the basic structure of the structural body 100 of the ultrafine bubble water generator according to the present invention, corresponding to claim 1 of the present application.

As shown in FIG. 1, the structural body 100 of a ultrafine bubble water generator (hereinafter referred to as “the structural body”) comprises: a circular water intake surface body 11 disposed on the inlet side of tap water, the water intake surface body 11 having branching holes 15, 16, 17, 18 for branching tap water flow into the interior of the structural body 100 into plural inflows; a circular water output surface body 12 disposed on the outlet side from the structural body 100, the water output surface body 12 having branching holes 15, 16, 17, 18 for branching the outflow of ultrafine bubble water produced inside of the structural body 100 into plural outflows; and a hollow cylindrical body 10 supporting the outer circumferential surfaces of the water intake surface body 11 and the water output surface body 12.

In this configuration, for the structural body 100, cylindrical body 10 having an appropriate outer diameter that fits the inner wall of a tap water supply pipe for supplying tap water or various water flowing tubes (hereinafter referred to as “tap water pipe”) as well as water intake surface body 11 and water output surface body 12 fitting the inner circumferential surface of the cylindrical body 10 may be used according to the size of tap water pipe, and inserted closely without gap from an inner tube surface of tap water pipe and installed for use.

In this way, the structural body 100 fits inner wall size of tap water pipe, and thus, you can install the structural body simply by cutting tap water pipe, inserting the structural body within a guiding water surface of one part of (cut) tap water pipe, and then aligning both cut surfaces of cut tap water pipes, and matching the aligned surfaces by use of adhesive agent such as waterproof tape etc.

In this way, user itself or operator can easily install the structural body 100 in a short time on the existing shower head and tools of toilet and lavatory already used in household, as well as water supply pipe or tube to an apparatus such as laundry machine and automatic dish washer. Additionally, you may secure the structural body 100 with adhesives etc. when inserting the structural body within tap water pipe.

By the way, the pipe diameter of tap water pipe is set to sizes of 20 mm, 25 mm, 32 mm and 40 mm. Therefore, cylindrical body 10 fitting the sizes, water intake surface body 11, water output surface body 12 and intermediate water flow diverter 13 and water flow blocker 14 described in the following are prepared in advance.

In the structural body 100, tap water vigorously flown from water intake surface body 11 having a plurality of branching holes becomes turbulent between water intake surface body 11 and water output surface body 12 and strikes the inner surface wall of cylindrical body 10, followed by flowing out from a plurality of branching holes made on the water output surface body 12 and striking inner circumferential wall of tap water pipe, thereby effectively making bubbling air or dissolved air in tap water finer bubbles.

Meanwhile, the resistance against water flow into generator in the structural body 100 is relatively low when compared to, for example, the conventional ultrafine bubble generators as shown in Patent Literature 2, Patent Literature 3 or FIG. 13 of the present application, thereby effectively generating many ultrafine bubbles without significantly reducing water pressure of tap water to be supplied from tap water pipe, in coordination with an action of ultrafine bubble water flowing out from water output surface body 12 striking the inner wall of tap water pipe.

FIG. 2 shows an example of the structural body 100 corresponding to claim 3 of the present application.

Compared to the first example of the structural body 100 as shown in FIG. 1, there is a difference that intermediate water flow diverter 13 is disposed between water intake surface body 11 and water output surface body 12 within cylindrical body 10. Intermediate water flow diverter 13 used herein may have the same shape as water intake surface body 11 and water output surface body 12 in most cases, but may have a different shape. The outer circumferential diameter of intermediate water flow diverter 13 may be the same as the outer circumferential diameter of water intake surface body 11 and water output surface body 12.

In the example of the structural body 100 as shown in FIG. 2, tap water passing through a plurality of branching holes 15 made on water intake surface body 11 strikes intermediate water flow diverter 13 to become vortex flow between water intake surface body 11 and intermediate water flow diverter 13. The vortex water flow strikes the wall of water output surface body 12 to become vortex flow between intermediate water flow diverter 13 and water output surface body 12, thereby flowing out from a plurality of branching holes 15 of water output surface body 12 to tap water pipe.

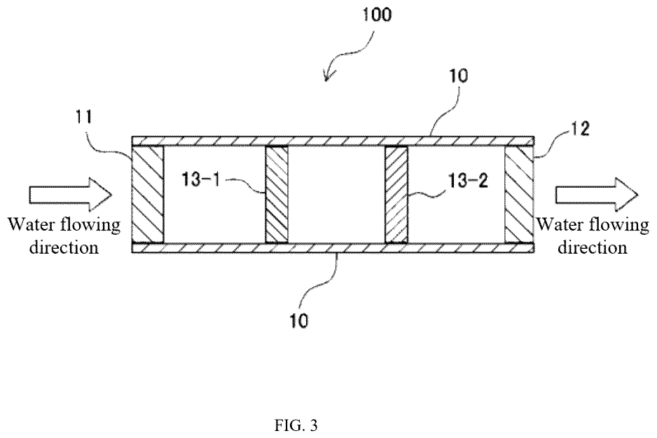

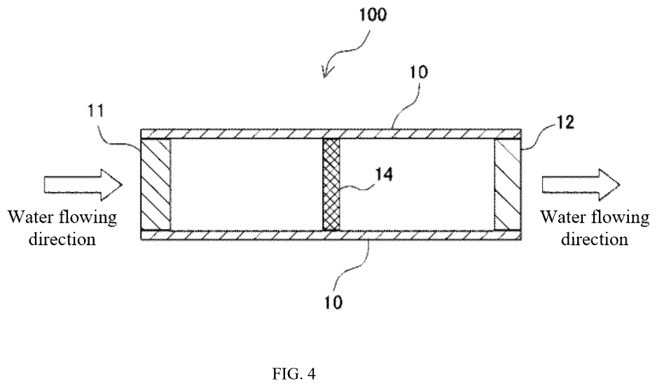

FIG. 3 shows the other embodiment of the structural body 100 of the ultrafine bubble water generator according to the present invention. Compared to the second example of the structural body 100 of FIG. 2, there is a difference that intermediate water flow diverters 13-1, 13-2 are disposed between water intake surface body 11 and water output surface body 12 within cylindrical body 10.

The first intermediate water flow diverter 13-1 used herein may usually be the same as the second intermediate water flow diverter 13-2, but may have different specs. The outer circumferential diameter of intermediate water flow diverter 13-2 may be the same as the outer circumferential diameter of intermediate water flow diverter 13-1, water intake surface body 11 and water output surface body 12.

In an example of the structural body 100 as shown in FIG. 3, when viewing each section between water intake surface body 11 and the first intermediate water flow diverter 13-1, between the first intermediate water flow diverter 13-1 and the second intermediate water flow diverter 13-2, and between the second intermediate water flow diverter 13-2 and water output surface body 12, tap water flow becomes vortex flow between intermediate water flow diverters 13-1, 13-2 and water output surface body 12 due to the invasion of tap water, and finally flowing out from a plurality of branching holes 15 of water output surface body 12. Therefore, ultrafine bubble water is produced more than the example as shown in FIG. 2, whereas water pressure of ultrafine bubble water flowing out from water output surface body 12 is reduced.

FIG. 4 shows an example in which water flow blocker was disposed in place of intermediate water flow diverter 13 in the example of the structural body 100 as shown in FIG. 2.

Water flow blocker 14 is shown in FIG. 12(a) or 12(b). The first example of water flow blocker is shown in FIG. 12(a), allowing water to flow at the central part in cylindrical body 10 of the structural body 100 with the circumferential part of cylindrical body 10 being blocked.

The second example of water flow blocker is shown in FIG. 12(b), allowing water to flow at the circumferential part in cylindrical body 10 of the structural body 100 with the central part of cylindrical body 10 being blocked. This causes turbulent flow of tap water between water intake surface body 11 and water flow blocker 14 and between water flow blocker 14 and water output surface body 12. Although the number of ultrafine bubbles is lower than the example of the structural body 100 of FIG. 2, the ability to produce ultrafine bubble water may be improved compared to the example of the structural body 100 of FIG. 1. In the example of the structural body 100 of FIG. 4, the water supply pressure of ultrafine bubble water from water output surface body 12 might be lower than the example of the structural body 100 of FIG. 1, however, might be higher than the example of the structural body 100 of FIG. 2.

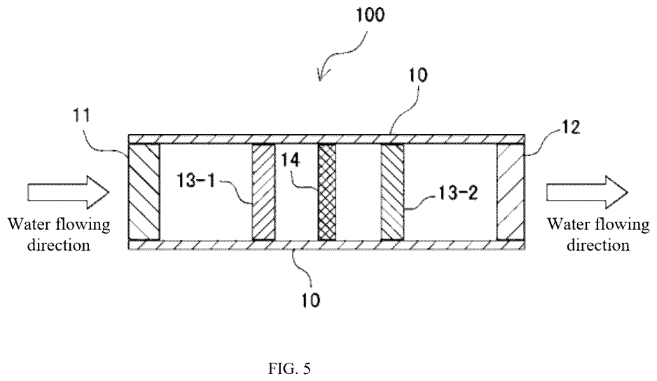

FIG. 5 shows an example in which water flow blocker was disposed between two intermediate water flow diverters 13-1, 13-2 in the example of the structural body 100 as shown in FIG. 3.

An example of FIG. 5 allows us to produce more ultrafine bubble water with finer bubbles compared to the example of the structural body 100 of FIG. 3. In the example of the structural body 100 of FIG. 5, the water supply pressure of ultrafine bubble water from water output surface body 12 might be somewhat lower than the example of the structural body 100 of FIG. 3. Thus it is advisable to apply to the place where supply pressure of tap water is relatively high.

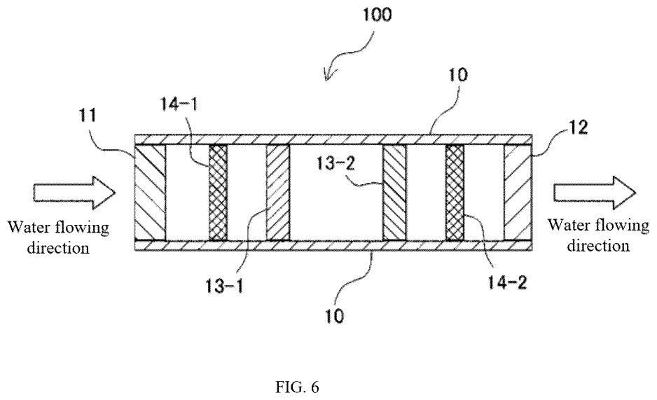

FIG. 6 shows an example in which water flow blockers 13-1 and 13-2 were disposed between water intake surface body 11 and intermediate water flow diverters 13-1 and between intermediate water flow diverters 13-2 and water output surface body 1 in the example of the structural body 100 as shown in FIG. 3. Water flow blockers 13-1 and 13-2 may be identical to or different from the type as shown in FIG. 12(a) and FIG. 12(b).

An example of FIG. 6 allows us to produce more ultrafine bubble water with finer bubbles compared to the example of the structural body 100 of FIG. 5. In the example of the structural body 100 of FIG. 6, the water supply pressure of ultrafine bubble water from water output surface body 12 might be somewhat lower than the example of the structural body 100 of FIG. 5. Thus it is advisable to apply to the place where supply pressure of tap water is high.

FIG. 7 shows an example of the shape of branching holes 15 made on the water flowing direction of water intake surface body 11, water output surface body 12 and intermediate water flow diverter 13 composing the structural body 100 of the ultrafine bubble water generator according to the present invention. (a) shows the example where three branching holes 15 are made vertical to the water flowing direction, whereas (b) shows the example where four circular branching holes 15 are made vertical to the water flowing direction. This allows tap water in the structural body 100 to divert into a plurality of water flows through a plurality of branching holes 15-1, 15-2, 15-3 or 15-4, whereas allowing tap water to strike the parts where no branching hole 15 is made on water intake surface body 11, water output surface body 12 and intermediate water flow diverter 13, which makes passing water turbulent in the structural body 100 and causes the difference in water pressure in each place within water flow, thereby effectively producing more ultrafine bubble water.

Similar to the example of the structural body 100 as shown in FIG. 7, FIG. 8 shows the positions of circular branching holes 16 viewed from the water flowing direction of water intake surface body 11, water output surface body 12 and intermediate water flow diverter 13-1. Unlike the example of the structural body 100 as shown in FIG. 7, (a) shows the example where three circular branching holes 16-1, 16-2, 16-3 are made so as to be tilted toward the water flowing direction, whereas (b) shows the example where four circular branching holes 16-1, 16-2, 16-3, 16-4 are made so as to be tilted toward the water flowing direction.

In the example of the structural body 100 of FIG. 8, branching hole tilts toward water flowing direction, which causes water flow between water intake surface body 11 and intermediate water flow diverter 13, water flow between intermediate water flow diverter 13 and water output surface body 12, and water flow flowing out from water output surface body 12 to twist and flow out while generating vortex, allowing us to produce more ultrafine bubble water with finer bubbles compared to the structural body 100 having branching holes 15 of FIG. 7.

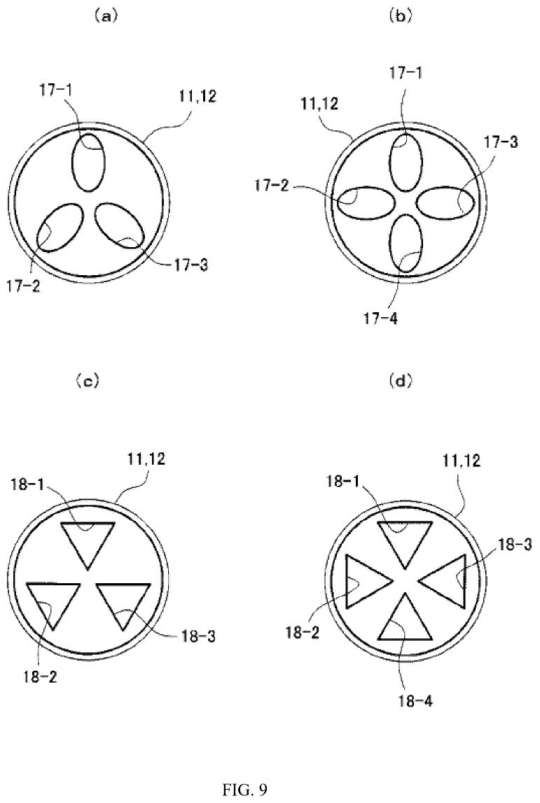

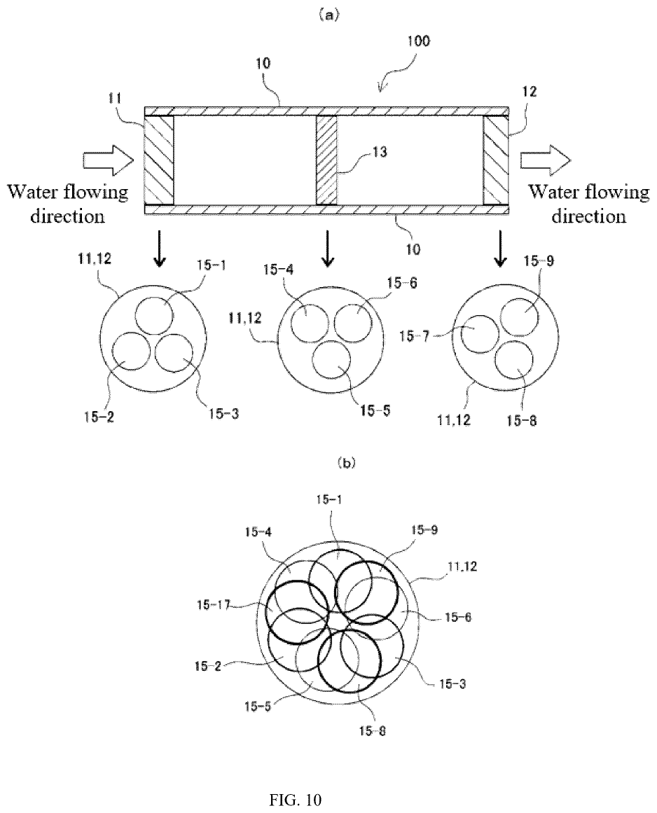

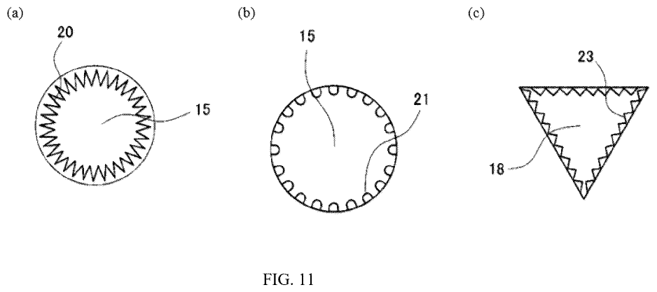

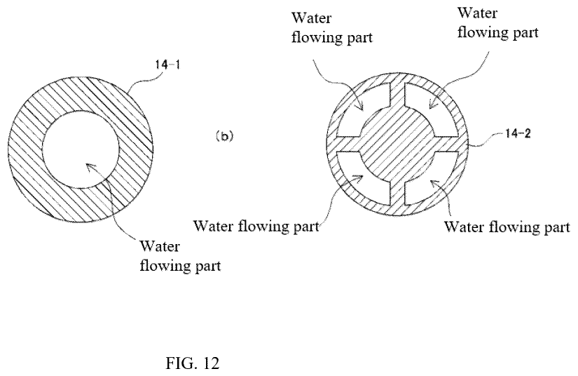

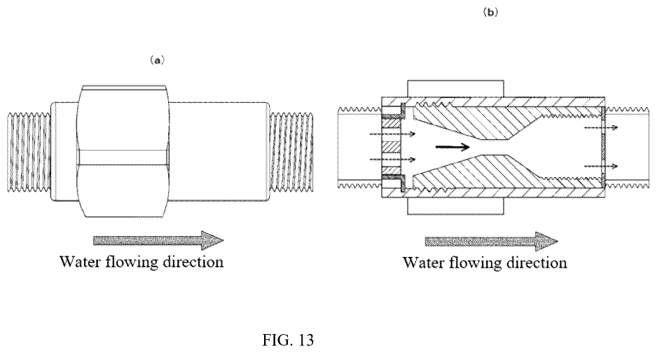

FIG. 9 shows one example of the shape of the branching holes other than circular shape viewed from the water flowing direction of water intake surface body, water output surface body and intermediate water flow diverter composing the structural body 100 of the ultrafine bubble water generators according to the present invention. (a) shows an example of three elliptical-shaped branching holes. (b) shows an example of four elliptical-shaped branching holes. (c) shows an example of three triangular-shaped branching holes. (d) shows an example of four triangular-shaped branching holes. Branching holes having each shape as shown in FIG. 9 may be made vertical to the water flow as shown in FIG. 7, or made so as to be tilted toward water flowing direction as shown in FIG. 8.

In an example of the structural body 100 as shown in FIG. 2 of the present application, FIG. 10 (a) shows an example of the relative position of each branching holes in the water intake surface body, water output surface body and intermediate water flow diverter when viewed from water flowing direction, and (b) shows the positions of the branching holes in the water intake surface body, water output surface body and intermediate water flow diverter when viewed from water flowing direction.

In this way, when viewed from water flowing direction from water intake surface body 11 to water output surface body 12, water intake surface body 11, water output surface body 12 and intermediate water flow diverter(s) 13 are disposed in such a manner that center positions of the respective branching holes may not coincide with each other but have a predetermined angle difference in a circumferential direction. Most of the water flowing out from each branching hole strikes a wall with no branching hole of intermediate water flow diverter(s) 13 and water output surface body 12 where no branching holes 15 are formed without simply passing through each branching hole, which allows us to effectively produce more ultrafine bubble water with finer bubbles.

FIG. 11 shows an example of irregularities for causing turbulent flow which are formed on inner surface of branching holes made on water intake surface body, water output surface body and intermediate water flow diverter.

FIG. 11(a) is an example of irregularities with a triangular shape made on water flowing surface of circular branching hole 15, FIG. 11(b) is an example of grain-like texture on water flowing surface of circular branching hole 12, and FIG. 11(c) is an example of irregularities with a triangular shape made on water flowing surface of triangular branching hole 18 as shown in FIG. 9(c) and (d). In this way, more ultrafine bubble water with finer bubbles may be produced by the irregularities made on the surface of branching holes 15, 16, 17 and 18 in water flowing direction or in a direction vertical to water flowing direction.

By the way, water intake surface body 11 and the water output surface body 12 may be made from a resin material, stainless material or braze material having a thickness of at least 6 mm.

A tilt of the branching holes 16 against the axis of the tap water supply pipe in the water intake surface body 11 of FIG. 8 may be opposite to a tilt of the branching holes 16 against the axis of the tap water supply pipe in the water output surface body 12. This makes water flow in the structural body 100 more turbulent.

In this way, intermediate water flow diverter(s) 13 is made from a resin material, stainless material or braze material having a thickness of at least 6 mm, similar to water intake surface body 11 and water output surface body 12. Branching holes in this intermediate water flow diverter(s) 13 may be disposed in a manner that center axes of branching holes may tilt against the axis of the tap water supply pipe toward the water flowing direction. When viewed from water flowing direction from water intake surface body 11 to water output surface body 12, water intake surface body 11, intermediate water flow diverter(s) 13 and water output surface body 12 may be disposed in such a manner that center positions of the respective branching holes may not coincide with each other but have a predetermined angle difference in a circumferential direction. A tilt of branching holes 15 against the axis of tap water supply pipe in water intake surface body 11 may be opposite to a tilt of branching holes 15 against the axis of tap water supply pipe in intermediate water flow diverter 13. Tap water flow in cylindrical body 10 of the structural body 100 changes its swirling direction by the tilt of each branching hole each time when tap water flow passes through water intake surface body 11, one or a plurality of the intermediate water flow diverter(s) 13 and water output surface body 12, thereby turning tap water flow into a great turbulent flow in the structural body 100 and effectively producing many ultrafine bubbles.

As aforementioned, the structural body 100 fundamentally comprises: a circular water intake surface body 11 disposed on the inlet side of tap water, the water intake surface body 11 having branching holes 15, 16, 17, 18 for branching tap water flow into the interior of the structural body 100 into plural inflows; a circular water output surface body 12 disposed on the outlet side from the structural body 100, the water output surface body 12 having branching holes 15, 16, 17, 18 for branching the outflow of ultrafine bubble water produced inside of the structural body 100 into plural outflows; and a hollow cylindrical body 10 supporting the outer circumferential surfaces of the water intake surface body 11 and the water output surface body 12 (FIG. 1). Based on this basic configuration, many variations are possible as illustrated in FIG. 2 to FIG. 6, according to the use, water pressure of tap water to be supplied, and the requirement of the nature of ultrafine bubble water.

Furthermore, for the structural body 100, cylindrical body 10 fitting various outer diameters of the inner wall of a tap water supply pipe as well as water intake surface body 11 and water output surface body 12 fitting the inner circumferential surface of the cylindrical body 10 may be selected according to the size of tap water pipe, and inserted into an inner pipe of the tap water pipe in advance and installed for use.

In this way, workers can easily install the structural body 100 in a short time on the existing shower heads, toilets, and lavatory fixtures already used in household, as well as water supply pipe or tube to an apparatus such as washing machine and automatic dishwasher.

What is claimed is:

1. A structural body of a ultrafine bubble water generator capable of making bubbles contained in tap water finer to produce water including many ultrafine bubbles, the structural body comprising:
a water intake surface body disposed on the inlet side of tap water, the water intake surface body having branching holes for branching tap water flow into the interior of the structure body into plural inflows;
a water output surface body on the outlet side from the structural body, the water output surface body having branching holes for branching the outflow of ultrafine bubble water produced inside of the structural body into plural outflows; and
a hollow cylindrical body supporting the outer circumferential surfaces of the water intake surface body and the water output surface body,
wherein the cylindrical body, the water intake surface body and the water output surface body of the structural body are selected to have an outer diameter that fits the inner wall of a tap water supply pipe for supplying the tap water or various water flowing tubes, and previously inserted and set in the tap water supply pipe.

2. The structural body of the ultrafine bubble water generator of claim 1, wherein the number of the branching holes in the water intake surface body is identical to the number of the branching holes in the water output surface body.

3. The structural body of the ultrafine bubble water generator of claim 1, further comprising one or a plurality of intermediate water flow diverter(s) inside the cylindrical body for branching water flow into plural flows in a water flowing channel from the water intake surface body to the water output surface body.

4. The structural body of the ultrafine bubble water generator of claim 3, wherein the branching holes in the water output surface body or the intermediate water flow diverter(s) respectively have a circular shape or an ellipsoidal shape.

5. The structural body of the ultrafine bubble water generator of claim 3, wherein the number of the branching holes in the intermediate water flow diverter(s) is identical to the number of the branching holes in the water intake surface body and the water output surface body.

6. The structural body of the ultrafine bubble water generator of claim 5, wherein the number of the branching holes in the water intake surface body, the water output surface body and the intermediate water flow diverter(s) is 3 or 4.

7. The structural body of the ultrafine bubble water generator of claim 6, wherein, when viewed from water flowing direction from the water intake surface body to the water output surface body, the water intake surface body, the water output surface body and the intermediate water flow diverter(s) are disposed in such a manner that center positions of the respective branching holes may not coincide with each other but have a predetermined angle difference in a circumferential direction.

8. The structural body of the ultrafine bubble water generator of claim 6, wherein the water intake surface body and the water output surface body are made from a resin material having a thickness of at least 6 mm, and the branching holes in the water intake surface body and the water output surface body are disposed in a manner that center axes of the branching holes may tilt against the axis of the tap water supply pipe toward the water flowing direction.

9. The structural body of the ultrafine bubble water generator of claim 7, wherein a tilt of the branching holes against the axis of the tap water supply pipe in the water intake surface body is opposite to a tilt of the branching holes against the axis of the tap water supply pipe in the water output surface body.

10. The structural body of the ultrafine bubble water generator of claim 8, wherein the intermediate water flow diverter(s) is made from a resin material having a thickness of at least 6 mm, and the branching holes in the intermediate water flow diverter(s) is disposed in a manner that center axes of the branching holes may tilt against the axis of the tap water supply pipe toward the water flowing direction.

11. The structural body of the ultrafine bubble water generator of claim 10, wherein, when viewed from water flowing direction from the water intake surface body to the water output surface body, the water intake surface body, the intermediate water flow diverter(s) and the water output surface body are disposed in such a manner that center positions of the respective branching holes may not coincide with each other but have a predetermined angle difference in a circumferential direction.

12. The structural body of the ultrafine bubble water generator of claim 11, wherein a tilt of the branching holes against the axis of the tap water supply pipe in the water intake surface body is opposite to a tilt of the branching holes against the axis of the tap water supply pipe in the intermediate water flow diverter(s).

13. The structural body of the ultrafine bubble water generator of claim 12, wherein a tilt of the branching holes made in the water intake surface body against the axis of the tap water supply pipe, a tilt of the branching holes in one or a plurality of the intermediate water flow diverter(s) and a tilt of the branching holes in the water output surface body are opposite to each other sequentially in water flowing direction, and each branching hole is arranged so that a tap water flow in a cylindrical body of the structural body may swirl by a tilt of each branching hole each time when the tap water flow passes through the water intake surface body, one or a plurality of the intermediate water flow diverter(s) and the water output surface body, thereby turning the tap water flow into a turbulent flow.

14. The structural body of the ultrafine bubble water generator of claim 11, wherein the branching holes in the water intake surface body, the water output surface body or the intermediate water flow diverter(s) are configured to have a concave/convex inner surface for producing turbulent flow.

15. The structural body of the ultrafine bubble water generator of claim 11, wherein the branching holes in the water intake surface body, the water output surface body or the intermediate water flow diverter(s) are configured to have a plurality of trenches for producing turbulent flow in a water flowing direction or a direction intersecting the water flowing direction.

16. A fine-bubble water generator, comprising: the structural body of the fine-bubble water generator of claim 3; and
one or a plurality of water flow blocker(s) supported by an inner wall within a cylindrical body of the structural body between the water intake surface body and the water output surface body, between the water intake surface body and the intermediate water flow diverter or between the intermediate water flow diverter and the water output surface body for blocking a part of water flow flowing within the cylindrical body.

17. The ultrafine bubble water generator of claim 16, wherein the water flow blocker is configured to block water flow flowing at central part within the cylindrical body of the structural body.

18. The ultrafine bubble water generator of claim 16, wherein the water flow blocker is configured to block water flow flowing at circumferential part within the cylindrical body of the structural body.
